(19) United States
(12) Patent Application Publication
(10) Pub. No.: US 2020/0334036 A1
(43) Pub. Date: Oct. 22, 2020

(54) INFORMATION PROCESSING SYSTEM AND RELAY DEVICE

(71) Applicant: FUJITSU CLIENT COMPUTING LIMITED, Kanagawa (JP)

(72) Inventors: Tatsuya Shimura, Kawasaki (JP); Akira Takeuchi, Kawasaki (JP)

(73) Assignee: FUJITSU CLIENT COMPUTING LIMITED, Kanagawa (JP)

(21) Appl. No.: 16/816,553

(22) Filed: Mar. 12, 2020

(30) Foreign Application Priority Data
Apr. 16, 2019 (JP) 2019-077820

(51) Int. Cl. G06F 9/22; G06F 9/26; G06F 8/65

(52) U.S. Cl. CPC G06F 9/223; G06F 8/65; G06F 9/268

(57) ABSTRACT

An information processing system includes a first information processing device, a second information processing device, and a relay device connected to the first/second information processing devices over different buses. The first information processing device updates firmware of the power control microcomputer and transmit, to the power control microcomputer, a reactivation instruction signal after the firmware is updated. The power control microcomputer: executes reactivation of the power control microcomputer when the reactivation instruction signal is received from the first information processing device; determines whether or not the executed reactivation is reactivation that is executed immediately after the firmware update; and supplies the operation voltage to the first information processing device when the power control microcomputer determines that the executed reactivation is reactivation immediately after the firmware update.

### CROSS-REFERENCE TO RELATED APPLICATIONS

This application is based upon and claims the benefit of priority from Japanese Patent Application No. 2019-077820, filed Apr. 16, 2019, the entire contents of which are incorporated herein by reference.

### FIELD

Embodiments described herein relate to an information processing system and a relay device.

### BACKGROUND

There is known an information processing system including a plurality of processors, a relay device provided with buses to which the plurality of processors can be connected. In such an information processing system, a technology has been developed, in which the relay device controls communication between the processors over the buses to perform distribution processing by the plurality of processors.

In the information processing system above, there is a case where power control of the plurality of processors is executed by the relay device. In this case, when firmware of a power control microcomputer mounted on the relay device is updated, supply of operating power necessary for operation of each of the processors may be shut off during the operation of the processor. Accordingly, in the related art, it may be difficult to secure normality of the information processing system.

### SUMMARY

An information processing system according to one aspect of the present disclosure includes a first information processing device, a second information processing device, and a relay device connected to the first information processing device and the second information processing device over different buses. The relay device is provided with a power control microcomputer to control supply of operation voltage to the first information processing device and the second information processing device. The first information processing device is configured to: update firmware of the power control microcomputer; and transmit, to the power control microcomputer, a reactivation instruction signal after the firmware is updated. The power control microcomputer of the relay device is configured to: execute reactivation of the power control microcomputer when the reactivation instruction signal is received from the first information processing device; determine whether or not the executed reactivation is reactivation that is executed immediately after the firmware update; and supply the operation voltage to the first information processing device when it is determined that the executed reactivation is reactivation immediately after the firmware update.

A relay device according to another aspect of the present disclosure is a relay device to which a first information processing device and a second information processing device are connected over different buses. The relay device includes a power control microcomputer to control supply of operation voltage to a first information processing device and a second information processing device. The power control microcomputer is configured to: execute reactivation of the power control microcomputer when a reactivation instruction signal is received from the first information processing device; determine whether or not the executed reactivation is reactivation that is executed immediately after firmware update of the power control microcomputer; and supply the operation voltage to the first information processing device when it is determined that the executed reactivation is reactivation immediately after the firmware update.

### BRIEF DESCRIPTION OF THE DRAWINGS

FIG. 1 is a diagram illustrating an example of a whole configuration of an information processing system according to an embodiment;

FIG. 2 is a diagram illustrating an example of a hardware configuration of the information processing system according to the embodiment;

FIG. 3 is a diagram illustrating an example of a software configuration of a platform of the information processing system according to the embodiment;

FIG. 4 is an explanatory diagram illustrating an example of communication processing between platforms according to the embodiment;

FIG. 5 is a diagram illustrating another platform viewed from an arbitrary platform according to the embodiment;

FIG. 6 is a diagram illustrating another platform viewed from an arbitrary platform according to the embodiment;

FIG. 7 is an explanatory diagram illustrating an example of a data transfer method between processors via a relay device according to the embodiment;

FIG. 8 is a block diagram illustrating an example of a functional configuration of the information processing system according to the embodiment;

FIG. 9 is a sequence diagram illustrating an example of a flow of firmware update according to the embodiment; and

FIG. 10 is a sequence diagram illustrating an example of a flow of firmware update according to a modification example.

### DETAILED DESCRIPTION

According to the aforementioned aspects of the present disclosure, it is possible to secure normality of the information processing system.

Hereinafter, an exemplary embodiment of the present disclosure will be disclosed. Note that, a configuration of the embodiment to be described below, and an operation and an effect obtained by the configuration are illustrative only. In addition, the following embodiment does not limit the technology of the present disclosure.

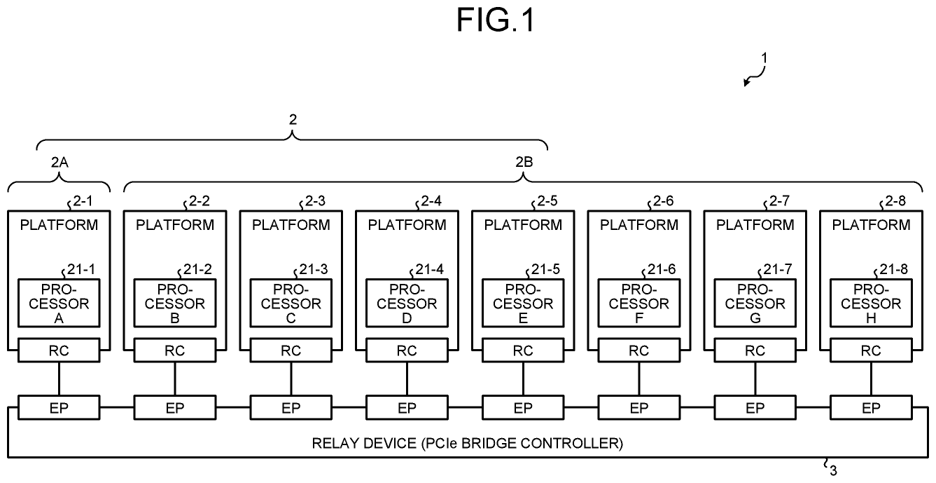

FIG. 1 is a diagram illustrating an example of a whole configuration of an information processing system 1 of an embodiment.

The information processing system 1 includes a plurality of platforms 2-1 to 2-8 and a relay device 3. Each of the plurality of platforms 2-1 to 2-8 is connected to the relay device 3.

In the following description, in a case where it is not necessary to distinguish the plurality of platforms 2-1 to 2-8 and an arbitrary platform is represented, the platform will be referred to as “a platform 2” or “platforms 2”. Note that, in this embodiment, description will be given of an example in which the information processing system 1 includes eight platforms 2 (platforms 2-1 to 2-8). However, the information processing system 1 may have a configuration including two or more platforms 2 and is not limited to the configuration of eight platforms 2.

The platform 2 is a device including a processor that executes various kinds of processing. In this embodiment, the platform 2 is a host personal computer (PC) functioning as a control unit and a graphical user interface (GUI) of the information processing system 1, and an operation unit that executes artificial intelligence (AI) inference processing, image processing, and the like.

In description of this embodiment, the platform 2 functioning as the control unit (host PC) of the information processing system 1 will be referred to as a first information processing device 2A. In addition, in the description, the platform 2 functioning as the operation unit will be referred to as a second information processing device 2B. In this embodiment, as an example, description will be given of an aspect in which one platform (for example, a platform 2-1) in a plurality of platforms 2 functions as the first information processing device 2A, and the others (for example, platforms 2-2 to 2-8) each function as the second information processing device 2B.

The platforms 2-1 to 2-8 include processors 21-1 to 21-8, respectively. In the following description, in a case where it is not necessary to distinguish the processors 21-1 to 21-8 and an arbitrary processor is represented, the processor will be referred to as “a processor 21” or “processors 21”. The processors 21-1 to 21-8 may be provided by different manufacturers, or may be provided by the same manufacturer.

For example, the processor 21-1 is provided by Company A, the processor 21-2 is provided by Company B, the processor 21-3 is provided by Company C, the processor 21-4 is provided by Company D, the processor 21-5 is provided by Company E, the processor 21-6 is provided by Company F, the processor 21-7 is provided by Company G, and the processor 21-8 is provided by Company H.

The relay device 3 relays communication between the platforms 2. In this embodiment, the relay device 3 uses PCI express (PCIe) to speed up communication between the platforms 2. The relay device 3 operates as a PCIe bridge controller that causes the processors 21 provided in the platforms 2 to operate as a root complex (RC) by using the PCIe, thereby realizing data transfer between end points (EPs) each operating as a device.

Specifically, in the information processing system 1, each of the processors 21 of the platforms 2 is caused to operate as the RC of the PCIe. On the other hand, the relay device 3 (that is, slots 305 to which the platforms 2 are connected) is caused to operate as the EP for each of the processors 21 (RCs) of the platforms 2.

With regard to a method of connecting the relay device 3 to each of the processors 21 of the platforms 2 as the EP, the method is implemented by using various known methods. For example, at the time of connection to the platform 2, the relay device 3 transmits a signal representing that relay device 3 functions as the EP, thereby being connected to the platform 2 as the EP.

The relay device 3 transfers data to a plurality of the RCs by tunneling the data by means of the end point to end point (EP-to-EP) communication. Communication between the processors 21 of the platforms 2 is logically established when transaction of the PCIe arises. On the other hand, when data transfer is not concentrated to one of the processors 21, the data transfer can be performed between the processors 21 in parallel.

Note that the EPs mounted on the relay device 3 may be connected to different platforms 2. In addition, one platform 2 may be connected to the EPs, and the platform 2 side may perform communication with the relay device 3 by using a plurality of the RCs.

Next, an example of a hardware configuration of the information processing system 1 of this embodiment will be described.

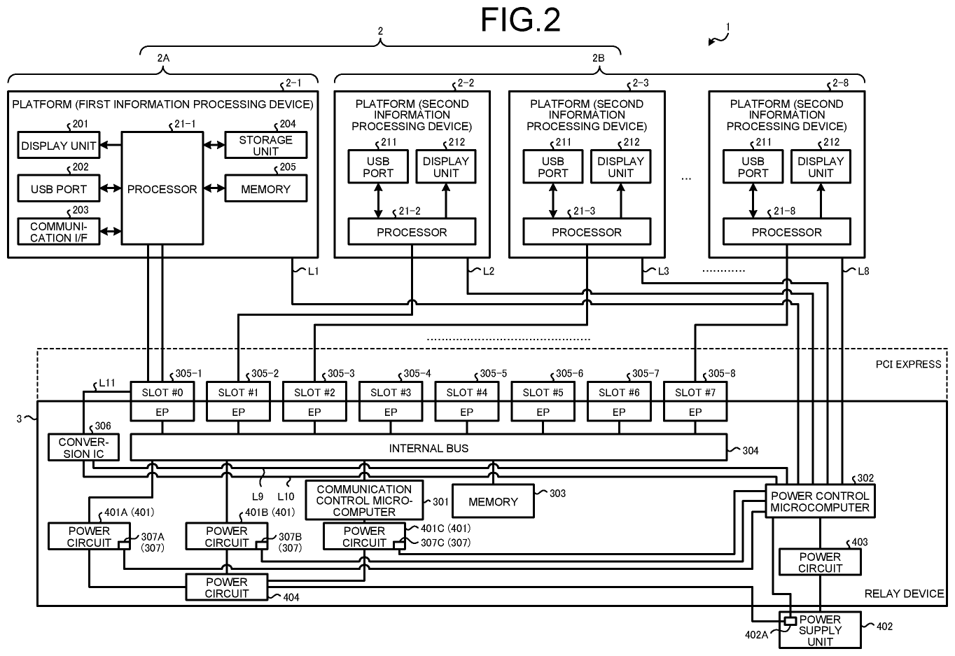

FIG. 2 is a diagram illustrating an example of the hardware configuration of the information processing system 1 of this embodiment.

Firstly, a hardware configuration of the platform 2-1 functioning as the first information processing device 2A will be described.

The platform 2-1 includes the processor 21-1, a display unit 201, a universal serial bus (USB) port 202, a communication I/F 203, a storage unit 204, and a memory 205. The display unit 201 is a liquid crystal display (LCD) or the like. The display unit 201 displays various pieces of information. The USB port 202 is a connector for connecting the platform 2-1 and peripheral devices to each other. The communication I/F 203 is able to communicate with a network such as a local area network (LAN) or the like in conformity to communication standards such as Ethernet (registered trademark).

The storage unit 204 is a storage device such as a hard disk drive (HDD), a solid state drive (SSD), and a storage class memory (SCM), and stores various pieces of data. The memory 205 is a read only memory (ROM), a random access memory (RAM), or the like. The ROM stores various software programs or data for the software programs. The software programs stored in the ROM are scanned and are executed by the processor 21-1. The RAM functions as a work region when the software programs stored in the ROM is executed.

The processor 21-1 is a hardware processor such as a central processing unit (CPU), a micro processing unit (MPU), a digital signal processor (DSP), an application specific integrated circuit (ASIC), a programmable logic device (PLD), and field programmable gate array (FPGA), and controls the entirety of the platform 2-1. The processor 21-1 may be a multicore processor, or a combination of two or more processors.

Next, a hardware configuration of each of the platforms 2-2 to 2-8 functioning as the second information processing device 2B will be described.

As an example, a hardware configuration of the platform 2-2 will be described. The platform 2-2 includes a processor 21-2, a USB port 211, and a display unit 212. The display unit 212 is an LCD or the like, and displays various pieces of information. The USB port 211 is a connector for connecting the platform 2-2 and peripheral devices to each other.

The processor 21-2 is a processor such as a CPU, an MPU, a DSP, an ASIC, a PLD, and an FPGA. The processor 21-2 controls the entirety of the platform 2-2. The processor 21-2 may be a multicore processor, or a combination of two or more processors. For example, the processor 21-2 may be a combination of the CPU and the GPU.

The remaining platforms (2-3 to 2-8) each functioning as the second information processing device 2B have the same hardware configuration as that of the platform 2-2 described above.

Next, a hardware configuration of the relay device 3 will be described.

The relay device 3 includes a communication control microcomputer 301, a power control microcomputer 302, a memory 303, a plurality of slots 305-1 to 305-8, a conversion integrated circuit (IC) 306, a power circuit 401, a power circuit 403, and a power circuit 404. The communication control microcomputer 301, the memory 303, the plurality of slots 305-1 to 305-8, and the power circuit 401 are connected to each other over an internal bus 304 in a communication possible manner.

Each of the slots 305-1 to 305-8 is an example of an extension slot (an extension bus or a bus). In this embodiment, a device compliant with the PCIe standards is connected to the slots 305-1 to 305-8. Specifically, the platforms 2-1 to 2-8 are connected to the slots 305-1 to 305-8. Accordingly, the plurality of platforms 2 (the first information processing device 2A and the second information processing devices 2B) are connected to the relay device 3 over different buses (extension buses or extension slots).

In the following description, in a case where it is not necessary to distinguish the slots 305-1 to 305-8 and an arbitrary slot is represented, the slot will be described as “a slot 305” or “slots 305”.

Note that, in the present embodiment, one of the platforms 2 is connected to one slot 305, but a plurality of the platforms 2 may be connected to the one slot 305. In addition, by allocating the slots 305 to the one platform 2, the platform 2 can perform communication in a wide communication band.

The memory 303 is a memory including the ROM and the RAM, for example. Various software programs, such as software programs relating to communication control between the platforms 2 connected to the slots 305, and pieces of data for the software programs are stored in the ROM of the memory 303. The software program stored in the ROM is scanned and executed by the communication control microcomputer 301. The RAM of the memory 303 functions as a work region when executing the software program stored in the ROM of the memory 303.

Note that memory regions are provided in the platforms 2 in correspondence with the slots 305, and a plurality of storage regions segmented into the number of slots 305 are set in the memory regions. Each of the storage regions is associated with any one of the slots 305. The relay device 3 performs data transfer between the platforms 2 on the basis of an address of the storage region provided for each of the slots 305.

The communication control microcomputer 301 executes the software program stored in the ROM of the memory 303 to implement communication between the platforms 2 connected to the slot 305. Specifically, the communication control microcomputer 301 includes a processor such as the CPU, the MPU, the DSP, the ASIC, the PLD, and the FPGA. The processor controls communication between the platforms 2 via the corresponding slots 305. The communication control microcomputer 301 may include a combination of two or more hardware processors.

The communication control microcomputer 301 operates by being supplied with power from a power supply unit 402 that is the same power supply unit as that in the platforms 2.

The power supply unit 402 is a power supply unit that supplies an operation voltage or a reference voltage.

The operation voltage is a voltage that enables the relay device 3 and the platforms 2 to operate. The operation voltage power is a voltage necessary for the relay device 3 and the platforms 2 to execute respective main functions (control of the information processing system 1, and operation processing such as AI interference processing and image processing). The operation voltage is 12 V, for instance. Note that, a value of the operation voltage is not limited to the value of 12 V.

The power supply unit 402 is a power supply unit for supplying a reference voltage that is less than the operation voltage of each of the platforms 2 and is equal to or greater than a voltage enabling the power control microcomputer 302 to operate. While the reference voltage is less than the operation voltage enabling the platforms 2 to execute the respective main functions (the operation processing such as the AI inference processing and the image processing), the reference voltage is a voltage enabling a minimum signal such as an activation instruction signal to be received. In addition, the reference voltage is a voltage enabling the power control microcomputer 302 to operate. For example, the reference voltage is 11 V. A value of the reference voltage is not limited to the value of 11 V.

The power supply unit 402 includes a change-over switch 402A. The change-over switch 402A is a switch for switching whether or not to supply the operation voltage (for example, 12 V) to the power circuit 404. The change-over switch 402A can be switched by control of the power control microcomputer 302 to be described later.

The power supply unit 402 supplies the reference voltage to the power circuit 403 without going through a switch. Thus, the reference voltage of 11 V or the like can be supplied to the power circuit 403 even in a case where supply of the operation voltage of 12 V or the like is shut off by the change-over switch 402A.

The power circuit 404 is a power circuit that generates power of a voltage of 12 V, 3 V, or 5 V by using power of the operation voltage supplied from the power supply unit 402 through the change-over switch 402A. The power circuit 404 supplies power to the power circuit 401. The power circuit 404 is a power circuit for converting the power of the operation voltage supplied from the power supply unit 402 to power for each module.

In the present embodiment, the power circuit 401 includes a power circuit 401A, a power circuit 401B, and a power circuit 401C. In addition, the power circuits 401A to 401C include change-over switches 307 (a change-over switch 307A, a change-over switch 307B, and a change-over switch 307C), respectively.

The power circuit 401A supplies the operation voltage to the first information processing device 2A over the internal bus 304 and the slot 305-1. The power circuit 401A includes the change-over switch 307A. The change-over switch 307A is controlled by the power control microcomputer 302 (details thereof will be described later).

The power circuit 401B supplies the operation voltage to each of the second information processing devices 2B over the internal bus 304 and the slots 305. The power circuit 401B includes the change-over switch 307B. The change-over switch 307B is controlled by the power control microcomputer 302 (details thereof will be described later). Note that, the operation voltage may be supplied from the power circuit 401B that is constituted as an individual unit for each of the second information processing devices 2B connected to the slots 305.

The power circuit 401C supplies the operation voltage to the communication control microcomputer 301. The power circuit 401C includes the change-over switch 307C. The change-over switch 307C is controlled by the power control microcomputer 302 (details thereof will be described later).

The power control microcomputer 302 controls supply of the operation voltage to the platforms 2 (the first information processing device 2A and the second information processing device 2B).

The power control microcomputer 302 includes a processor such as the CPU, the MPU, the DSP, the ASIC, the PLD, and the FPGA, and the processor controls supply of the operation voltage with respect to the platforms 2 (the first information processing device 2A and the second information processing device 2B) connected to the relay device 3 and the slots 305. The processor of the power control microcomputer 302 may include a combination of a plurality of processors. In addition, the processor of the power control microcomputer 302 controls the operation voltage supplied from the power circuits 401 to the platforms 2 connected to the slots 305 by executing a software program stored in a memory provided in the power control microcomputer 302.

The power control microcomputer 302 is connected to the power circuits 401 via the change-over switches 307. The change-over switches 307 function as hardware-type change-over switches for supply (ON) and shut-off (OFF) of the operation voltage to the first information processing device 2A, the second information processing device 2B, and the communication control microcomputer 301.

The change-over switches 307 include the change-over switch 307A, the change-over switch 307B, and the change-over switch 307C.

The change-over switch 307A is a change-over switch configured to switch ON and OFF of the operation voltage supplied from the power circuit 401A to the first information processing device 2A in a hardware manner. The change-over switch 307A is connected to the power control microcomputer 302 by a signal line. The signal line is a signal line that is connected between dedicated terminals such as general-purpose input/output (GPIO) of the power control microcomputer 302.

The change-over switch 307A can be switched by control of the power control microcomputer 302. In a case where the change-over switch 307A is in a state of being switched to supply (ON) of the operation voltage, the operation voltage is supplied from the power circuit 401A to the first information processing device 2A via the slot 305. On the other hand, in a case where the change-over switch 307A is in a state of being switched to supply shut-off (OFF) of the operation voltage, it enters a state in which supply of the operation voltage from the power circuit 401A to the first information processing device 2A is shut off.

The change-over switch 307B is a change-over switch that switches ON and OFF of the operation voltage supplied from the power circuit 401B to the second information processing device 2B in a hardware manner. The change-over switch 307B is connected to the power control microcomputer 302 by a signal line. The signal line is a signal line that is connected between dedicated terminals such as the GPIO of the power control microcomputer 302.

The change-over switch 307B is switched by control of the power control microcomputer 302. In a case where the change-over switch 307B is in a state of being switched to supply (ON) of the operation voltage, the operation voltage is supplied from the power circuit 401B to the second information processing device 2B via the slot 305. On the other hand, in a case where the change-over switch 307B is in a state of being switched to supply shut-off (OFF) of the operation voltage, it enters a state in which supply of the operation voltage from the power circuit 401B to the second information processing device 2B is shut off.

The change-over switch 307C is a change-over switch that switches ON and OFF of the operation voltage supplied from the power circuit 401C to the communication control microcomputer 301 in a hardware manner. The change-over switch 307C is connected to the power control microcomputer 302 by a signal line. The signal line is a signal line that is connected between dedicated terminals such as the GPIO of the power control microcomputer 302.

The change-over switch 307C is switched by control of the power control microcomputer 302. In a case where the change-over switch 307C is in a state of being switched to supply (ON) of the operation voltage, the operation voltage is supplied from the power circuit 401C to the communication control microcomputer 301 via the slot 305. On the other hand, in a case where the change-over switch 307C is in a state of being switched to supply shut-off (OFF) of the operation voltage, it enters a state in which supply of the operation voltage from the power circuit 401C to the communication control microcomputer 301 is shut off.

As described above, the power control microcomputer 302 controls supply and supply shut-off of the operation voltage and supply shut of the operation voltage to the platforms 2 and the communication control microcomputer 301 by switching the change-over switches 307.

The power control microcomputer 302 operates by being supplied with the power from the power supply unit 402. Specifically, as described above, the power supply unit 402 supplies power of the reference voltage of 11 V to the power circuit 403. The power circuit 403 is a power circuit for converting power of the reference voltage supplied from the power supply unit 402 into power for respective modules. According to this, the power control microcomputer 302 is supplied with power converted from the reference voltage from the power circuit 403.

In addition, the power control microcomputer 302 is connected to the platforms 2-1 to 2-8 via the slots 305-1 to 305-8 over signal lines L1 to L8. The signal lines L1 to L8 are signal lines over which signals input from the platforms 2-1 to 2-8 are transferred to the power control microcomputer 302. The signal lines L1 to L8 are signal lines connected between dedicated terminals, such as GPIO, in each of the platforms 2 and the power control microcomputer 302.

The conversion IC 306 outputs various signals which are given in notification from the first information processing device 2A connected to the slot 305-1 to the power control microcomputer 302. Specifically, the conversion IC 306 is connected to the power control microcomputer 302 over a signal line L9 and a signal line L10.

The conversion IC 306 receives the various signals transmitted from the first information processing device 2A connected to the slot 305-1 over a signal line L11 via the slot 305-1 having a universal serial bus (USB) standard. Examples of the signal to be transmitted from the first information processing device 2A include an update instruction signal, a reactivation instruction signal, and the like (details thereof will be described later).

The conversion IC 306 outputs the received signals to the power control microcomputer 302 over the signal line L9 or the signal line L10 which corresponds to each of the received signals.

The signal line L9 is, for example, a signal line compliant with a serial bus standard defined in inter-integrated-circuit (I2C). For example, the conversion IC 306 outputs the update instruction signal to the power control microcomputer 302 over the signal line L9.

The signal line L10 is a signal line that is connected to dedicated terminals such as the GPIO of the power control microcomputer 302. For example, the conversion IC 306 outputs the reactivation instruction signal to the power control microcomputer 302 over the signal line L10.

The power control microcomputer 302 executes firmware update, reactivation, and the like on the basis of signals received from the conversion IC 306 (details will be described later).

Next, an example of a software configuration of the platforms 2 of the information processing system 1 will be described.

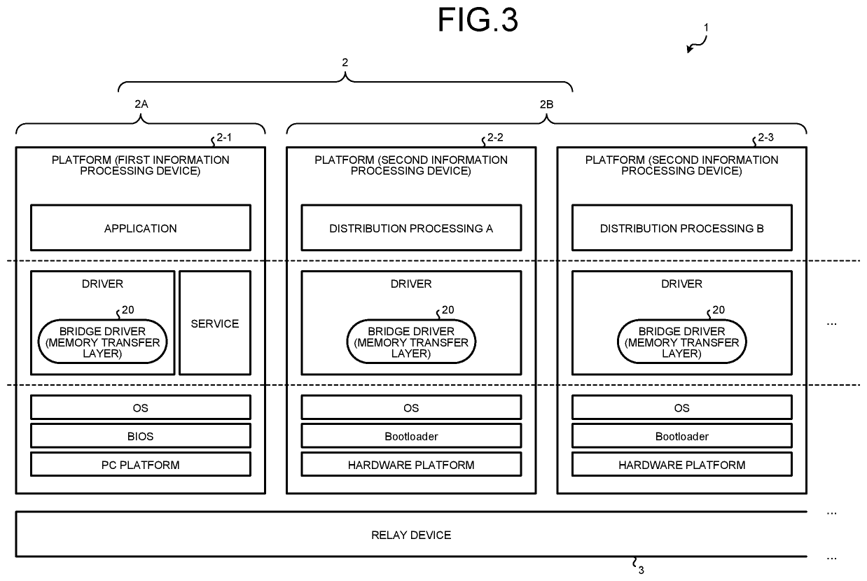

FIG. 3 is a diagram illustrating an example of the software configuration of the platforms of the information processing system 1 of this embodiment.

The first information processing device 2A as the platform 2-1 executes, for example, various software programs on an operating system (OS) in a state in which Windows (registered trademark) is set as the OS. The second information processing device 2B as the platforms 2-2 and 2-3 executes, for example, various software programs on an OS in a state in which Linux (registered trademark) is set as the OS.

A bridge driver 20 is provided in each of the platforms 2, and communication with the relay device 3 and the other platforms 2 via the bridge driver 20. The platform 2 includes a processor 21 and a memory. Various functions of the platform 2 are implemented when the processor 21 executes the OS, various programs, a driver, and the like which are stored in the memory.

Next, an example of communication processing between the platforms 2 connected to the relay device 3 will be described.

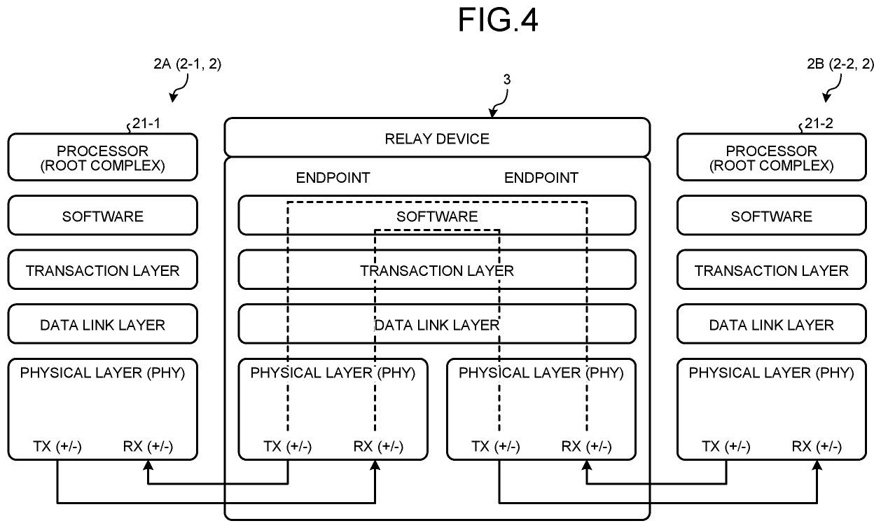

FIG. 4 is an explanatory diagram illustrating an example of the communication processing between the platforms 2. In FIG. 4, communication processing between the processor 21-1 of the platform 2-1 as the first information processing device 2A and the processor 21-2 of the platform 2-2 as the second information processing device 2B is illustrated as an example.

In the platform 2-1 as a transmission source, data generated in the processor 21-1 as an RC is transferred in the order of software, a transaction layer, a data link layer, and a physical layer (PHY), as shown in FIG. 4. Then, the data is transferred from the physical layer to a physical layer of the relay device 3.

In the relay device 3, the data transferred from the platform 2-1 as the transmission source is transferred in the order of the physical layer, a data link layer, a transaction layer, and software. Then, the data is transferred by tunneling to an EP corresponding to the RC of the platform 2-2 as the transmission destination. That is, the relay device 3 transfers (relays) data from one RC (processor 21-1) to another RC (processor 21-2) by tunneling the data between the EPs.

In the platform 2-2 that is a transmission destination, the data transferred from the relay device 3 is transferred in the order of a physical layer (PHY), a data link layer, a transaction layer, and software. In addition, the data is transferred to the processor 21-2 of the platform 2-2 that is the transmission destination. In the information processing system 1 of this embodiment, communication between the platforms 2 is logically implemented when transaction of the PCIe arises.

In a case where data transfer from a plurality of the platforms 2 is not concentrated to a platform 2 that is connected to one of a plurality of the slots 305 provided in the relay device 3, data transfer can be executed in parallel between a plurality of arbitrary different sets of the platforms 2. For example, it is assumed that the processor 21-2 of the platform 2-2 and the processor 21-3 of the platform 2-3 perform communication with the processor 21-1 of the platform 2-1. In this case, the relay device 3 serially processes communication by the processor 21-2 of the platform 2-2 and the processor 21-3 of the platform 2-3.

On the other hand, it is assumed that processors 21 of other platforms 2 perform communication and communication is not concentrated to a processor 21 of a specific platform 2. In this case, the relay device 3 can process communication between the platforms 2 in parallel.

Next, a processor 21 of another platform 2 viewed from a processor 21 of a platform 2 will be described.

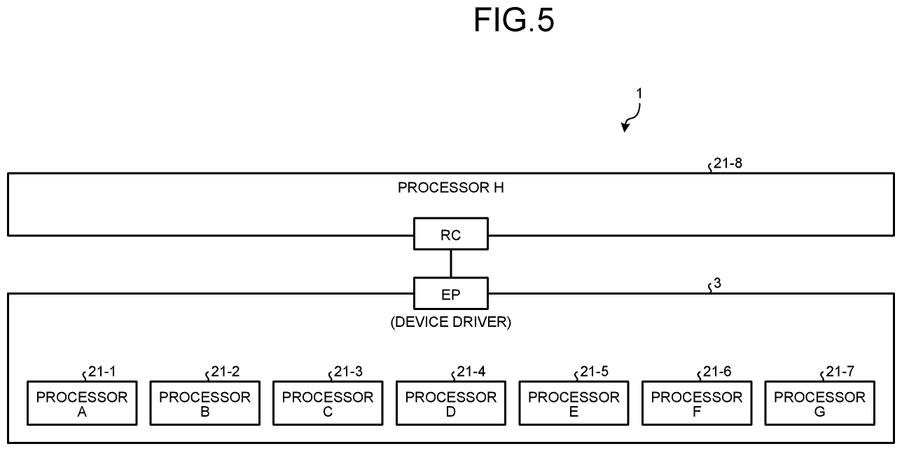

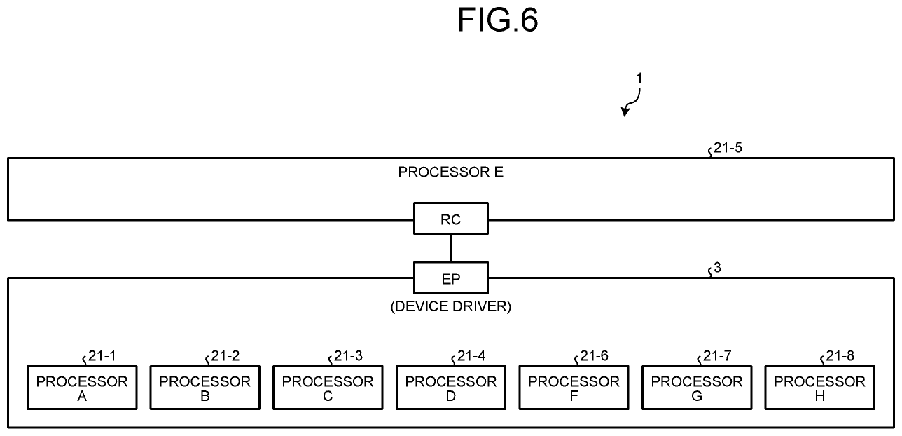

FIG. 5 and FIG. 6 are diagrams illustrating another platform 2 viewed from an arbitrary platform 2 in the information processing system 1 of this embodiment.

A state in which communication is being performed between the processors 21 of the platforms 2 is assumed. In the case of this state, only the relay device 3 viewed from an OS (for example, a device manager of Windows (registered trademark)) that is executed by the processors 21. Accordingly, it is not necessary for the platform 2 as a transmission source to directly manage the processor 21 of another platform 2 that is a transmission destination. That is, a device driver of the relay device 3 manages the processor 21 of the platform 2 that is connected to the relay device 3.

Accordingly, in the information processing system 1, it is not necessary to prepare a device driver for operating the processors 21 of the platforms 2 working as the transmission source and the transmission destination. In addition, in the information processing system 1, it is possible to implement communication between the platforms 2 only by performing communication processing in the device driver of the relay device 3.

Next, a data transfer method between the platforms 2 via the relay device 3 will be described.

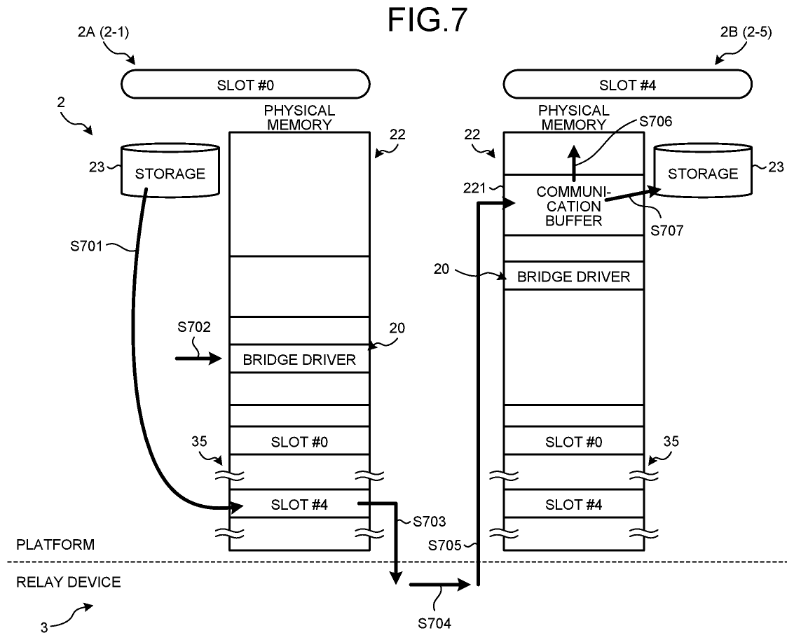

FIG. 7 is an explanatory diagram illustrating an example of a data transfer method between processors via the relay device 3 in the information processing system 1 of this embodiment.

In FIG. 7, data is transferred from the platform 2-1 connected to a Slot #0 of the relay device 3 to the platform 2-5 connected to a Slot #4 of the relay device 3.

The platform 2-1 as a transmission source stores, in a memory region 35 of the platform 2-1, data (hereinafter, referred to as “transmission data”) which has been stored in a storage 23 provided in the platform 2-1 and is transmitted therefrom by software or the like (Step S701). The memory region 35 may be part of a communication buffer in which the transferred data is temporarily stored. The memory region 35 is a region that is provided in each of the platforms 2 in the same size as in a memory 22 or the like. The memory region 35 has been segmented into the number of the slots 305. Each of segmented storage regions of the memory region 35 is associated with any one of the slots 305. For example, a storage region represented by Slot #0 in the memory region 35 is associated with the platform 2-1 connected to Slot #0, and a storage region represented by Slot #4 in the memory region 35 is associated with the platform 2-5 connected to Slot #4. The platform 2-1 stores the transmission data in a region (herein, Slot #4) allocated to the slot 305 of a transmission destination in the memory region 35.

The bridge driver 20 acquires or generates slot information representing the slot 305 of a transmission destination and address information representing an address in the segmented regions in the memory region 35 of the transmission destination on the basis of the storage region of the memory region 35 of the platform 2 (Step S702).

In an EP of a transmission source, the bridge driver 20 transmits transfer data including slot information, address information, and transmission data to the relay device 3 (Step S703). The relay device 3 connects the slot 305 of the transmission source and the slot 305 of the transmission destination by the EP-to-EP on the basis of the slot information, thereby transferring the transfer data to the platform 2-4 as the transmission destination (Step S704). The bridge driver 20 of the transmission destination stores the transmission data (or transfer data) in an address region, which is represented by address information, in a storage region corresponding to a communication buffer 221 of the platform 2 as the transmission destination on the basis of the slot information and the address information (Step S705).

In the platform 2-5 as the transmission destination, a program reads out the transmission data from the communication buffer 221 and loads the transmission data to the memory (local memory) 22 or the storage 23 (Step S706 or Step S707).

In the manner described above, data (transfer data) is transferred from the platform 2-1 as the transmission source to the platform 2-5 as the transmission destination.

By the way, in the information processing system 1 having the above-described configuration, respective blocks of the first information processing device 2A (the platform 2-1), each of the second information processing devices 2B (the platforms 2-2 to 2-8), and the relay device 3 operate independently.

In addition, as described above, the power control microcomputer 302 of the relay device 3 controls supply of the operation voltage to each of the platforms 2 and the communication control microcomputer 301 and supply shut-off of the operation voltage.

Firmware of the power control microcomputer 302 may be updated. The firmware is a software program for directly controlling hardware of the power control microcomputer 302.

The update of the firmware of the power control microcomputer 302 is executed by a boot loader dedicated to rewriting of the firmware. According to this, supply control of the operation voltage to the platforms 2 and the communication control microcomputer 301 by the power control microcomputer 302 is not executed during firmware update. In addition, when the power control microcomputer 302 is reactivated after the firmware update, an operation of the microcomputer 302 starts with the updated firmware. However, at this time, a supply control unit of the power control microcomputer 302 is initialized (typically, initial setting is power-off), so that supply of the operation voltage to each of the platforms 2 may be forcibly shut off. As a result, an operable operation voltage (for example, 12 V) is not supplied to the platforms 2.

Therefore, due to the firmware update, supply of the operation voltage to the platforms 2 which are executing various kinds of processing is suddenly shut off, and thus a problem may occur in the platforms 2. Accordingly, it may be difficult to secure normality of the entirety of the information processing system 1.

Considering above, in the information processing system 1 of the present embodiment, by providing functions described below, normality of the entirety of the information processing system 1 is secured even in a case where firmware update of the power control microcomputer 302 is performed.

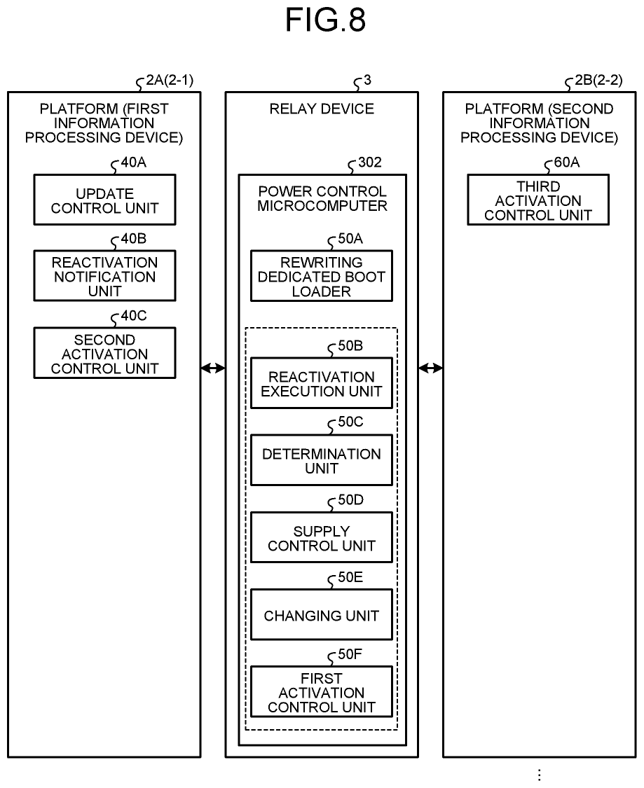

FIG. 8 is a block diagram illustrating an example of a functional configuration example of the information processing system 1 of this embodiment.

Respective functions of the first information processing device 2A, the relay device 3, and the second information processing device 2B as illustrated in FIG. 8 are implemented when the processors 21 of the first information processing device 2A, the relay device 3, and the second information processing device 2B read out and execute software program stored in each memory.

Firstly, a functional configuration of the first information processing device 2A will be described.

The first information processing device 2A includes an update control unit 40A, a reactivation notification unit 40B, and a second activation control unit 40C.

The update control unit 40A updates firmware of the power control microcomputer 302 provided in the relay device 3. Specifically, the update control unit 40A transmits an update instruction signal to the relay device 3 via the slot 305-1 to which the first information processing device 2A is connected. The update instruction signal includes an update signal and update firmware. The update firmware is firmware (program) that is used in update. The update control unit 40A transmits one or a plurality of update instruction signals to the relay device 3. The power control microcomputer 302 of the relay device 3 updates the firmware of the power control microcomputer 302 by using update firmware included in the received update instruction signal (details will be described later). Accordingly, the firmware of the power control microcomputer 302 is updated by control by the update control unit 40A.

In addition, the update control unit 40A transmits a shut-down instruction signal to the second information processing device 2B before the firmware update of the power control microcomputer 302. The shut-down instruction signal is a signal that makes a request for the second information processing device 2B to shut down the second information processing device 2B. The update control unit 40A transmits, via the relay device 3, the shut-down instruction signal to the second information processing device 2B connected to the slot 305. The reactivation notification unit 40B transmits a reactivation instruction signal to the power control microcomputer 302 before and after the firmware of the power control microcomputer 302 is updated. The reactivation instruction signal is an instruction signal that makes a request for reactivation.

The second activation control unit 40C executes shut-down processing of the first information processing device 2A after the power control microcomputer 302 is notified of the reactivation instruction signal by the reactivation notification unit 40B.

In addition, the second activation control unit 40C transmits a shut-down completion notification to the power control microcomputer 302 over the signal line L1 after executing the shut-down processing.

Next, a functional configuration of the power control microcomputer 302 of the relay device 3 will be described.

The power control microcomputer 302 includes a rewriting dedicated boot loader 50A, a reactivation execution unit 50B, a determination unit 50C, a supply control unit 50D, a changing unit 50E, and a first activation control unit 50F.

The functional units (the reactivation execution unit 50B, the determination unit 50C, the supply control unit 50D, the changing unit 50E, and the first activation control unit 50F) other than the rewriting dedicated boot loader 50A are pieces of firmware relating to power control. Note that the “power control” represents control of supply of the operation voltage to the first information processing device 2A, the second information processing device 2B, and the communication control microcomputer 301. In this embodiment, firmware to be updated is the firmware relating to the power control.

When an update instruction signal is received from the first information processing device 2A, the rewriting dedicated boot loader 50A executes firmware update of the power control microcomputer 302. Specifically, the rewriting dedicated boot loader 50A receives the update instruction signal from the conversion IC 306. Then, the conversion IC 306 outputs the update instruction signal received from the first information processing device 2A to the power control microcomputer 302 over the signal line L9. The rewriting dedicated boot loader 50A receives the update instruction signal from the first information processing device 2A through the conversion IC 306.

As described above, an update instruction and update firmware are included in the update instruction signal. The rewriting dedicated boot loader 50A installs the update firmware included in the received update instruction signal and updates the firmware (firmware related to the power control) of the power control microcomputer 302. Note that, in a case where a plurality of update instruction signals are received, the rewriting dedicated boot loader 50A installs update firmware included in each of the received update instruction signals to sequentially update pieces of firmware of the power control microcomputer 302.

Upon receiving a reactivation instruction signal from the first information processing device 2A, the reactivation execution unit 50B executes reactivation of the power control microcomputer 302.

Specifically, the reactivation execution unit 50B receives the reactivation instruction signal from the conversion IC 306. The conversion IC 306 outputs the reactivation instruction signal received from the first information processing device 2A to the power control microcomputer 302 over the signal line L10. According to this, the reactivation execution unit 50B receives the reactivation instruction signal from the conversion IC 306, and executes reactivation of the power control microcomputer 302.

When the power control microcomputer 302 is reactivated, the determination unit 50C determines whether or not the reactivation is reactivation that was executed immediately after the firmware update of the power control microcomputer 302. For example, the power control microcomputer 302 may determine whether or not the reactivation is reactivation immediately after the update by specifying a date of the firmware update and a timing of the reactivation. Note that a method of determining whether or not the reactivation is reactivation immediately after the update is not limited to the above-described method.

In a case where it is determined that the reactivation is reactivation immediately after the firmware update, the supply control unit 50D performs control of supplying the operation voltage to the first information processing device 2A.

As described above, during the firmware update of the power control microcomputer 302, supply of the operation voltage by the power control microcomputer 302 is not executed. However, when the power control microcomputer 302 is reactivated after the firmware update, a control situation of the operation voltage to the platforms 2 is reset, and thus supply of the operation voltage to each of the platforms 2 may be forcibly shut off.

Considering above, in the present embodiment, in a case where it is determined that the reactivation is reactivation immediately after the firmware update, the supply control unit 50D controls the change-over switch 307A and the change-over switch 402A to supply the operation voltage to the first information processing device 2A.

In a stage before the firmware update, the change-over switch 402A that switches ON and OFF of the operation voltage supplied from the power supply unit 402 to the relay device 3 in a hardware manner, and the change-over switch 307A that switches ON and OFF of the operation voltage supplied from the power circuit 401A to the first information processing device 2A in a hardware manner are in an operation voltage supply (ON) state. Accordingly, in a case where it is determined that the reactivation is reactivation immediately after the firmware update, the supply control unit 50D does not the change-over switch 402A and the change-over switch 307A to an operation voltage supply shut-off (OFF) state. Accordingly, the change-over switch 402A and the change-over switch 307A are maintained in the operation voltage supply (ON) state before the firmware update, during the firmware update, and over a reactivation period after the firmware update.

Accordingly, in the first information processing device 2A, supply of the operation voltage is continued without shut-off of supply of the operation voltage before the firmware update, during the update, in reactivation after the update, and for a period immediately after the reactivation. According to this, in a case where the firmware of the power control microcomputer 302 is updated, the supply of the operation voltage to the first information processing device 2A is suppressed from being suddenly shut off. Accordingly, in this embodiment, the normality of the information processing system 1 is secured.

Here, as described above, the power control microcomputer 302 controls supply of the operation voltage to the platforms 2 (the first information processing device 2A and the second information processing device 2B). Thus, the power control microcomputer 302 holds and manages, as state information, a power control situation of the first information processing device 2A and the second information processing device 2B. For example, the power control microcomputer 302 stores the state information in a memory in the power control microcomputer 302, and updates the state information in correspondence with the power control situation.

Specifically, for example, the state information includes information representing that the operation voltage (for example, a voltage of 12 V) is being supplied or supply of the operation voltage is being shut-off as power control information of the first information processing device 2A. In addition, the state information includes information representing that the operation voltage is being supplied, or representing that supply of the operation voltage is being shut-off as power control information of the second information processing device 2B. Note that the state information may further include other pieces of information.

When the firmware of the power control microcomputer 302 is updated and the power control microcomputer 302 is reactivated, the state information is initialized. An initialized state is a state in which power control information that is included in the state information and relates to each of the first information processing device 2A and the second information processing device 2B represents operation voltage supply shut-off.

In a case where it is determined that the reactivation is reactivation immediately after firmware update, the changing unit 50E changes the state information, which has been initialized due to the executed reactivation, to indicate that the operation voltage is being supplied to the first information processing device 2A (supply of the operation voltage to the second information processing device 2B and the communication control microcomputer is being shut-off). As a result, the state information is updated to indicate content corresponding to an actual power control situation.

In a case where it is determined that the reactivation is reactivation immediately after firmware update of the power control microcomputer 302, the first activation control unit 50F executes shut-down processing of the relay device 3 after supplying the operation voltage to the first information processing device 2A.

As described above, when the shut-down is completed after executing the shut-down processing, the second activation control unit 40C of the first information processing device 2A transmits a signal representing shut-down completion to the power control microcomputer 302 over the signal line L1. Thus, the first activation control unit 50F may execute the shut-down processing of the relay device 3 at the time when the signal representing the shut-down completion is received from the first information processing device 2A.

Note that, in a case where the determination unit 50C determines that the reactivation is not reactivation immediately after the firmware update, the supply control unit 50D may control the change-over switch 307A and the change-over switch 402A so that supply of the operation voltage to the first information processing device 2A and the relay device 3 is shut off.

In this case, the supply control unit 50D switches the change-over switch 307A and the change-over switch 402A to the operation voltage supply shut-off (OFF) state. Accordingly, in a case where it is determined the reactivation is not reactivation immediately after the firmware update, supply of the operation voltage to the first information processing device 2A is shut off.

Next, a functional configuration of the second information processing device 2B will be described.

The second information processing device 2B includes a third activation control unit 60A.

Upon receiving a shut-down instruction signal from the relay device 3, the third activation control unit 60A executes shut-down processing of the second information processing device 2B. After executing the shut-down processing, the third activation control unit 60A notifies the power control microcomputer 302 of a shut-down completion over the signal lines L2 to L8.

As described above, the update control unit 40A of the first information processing device 2A transmits the shut-down instruction signal to the second information processing device 2B via the relay device 3 before the firmware update of the power control microcomputer 302. Accordingly, in the information processing system 1, the platform 2 is shut down before the firmware update of the power control microcomputer 302.

Therefore, even in a case where the firmware of the power control microcomputer 302 is updated, the second information processing devices 2B are shut down in a normal sequence in advance, so that supply of the operation voltage is suppressed from being suddenly shut off during execution of various kinds of processing. As a result, normality of the information processing system 1 is secured.

Next, description will be given of an example of a flow of processing relating to the firmware update of the power control microcomputer 302 in the information processing system 1 of this embodiment.

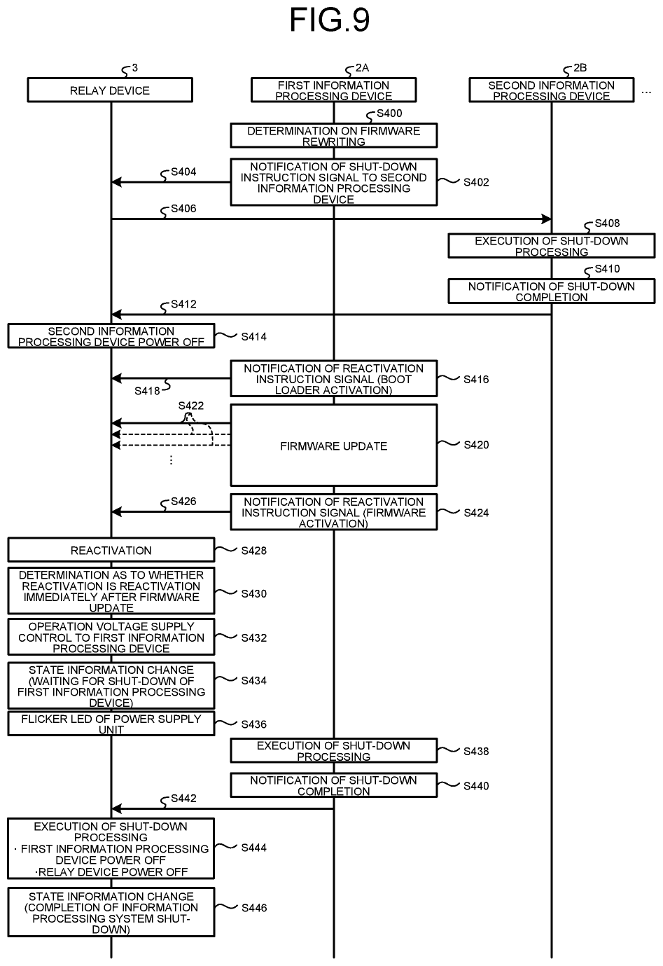

FIG. 9 is a sequence diagram illustrating an example of a flow of the firmware update in the information processing system 1 of this embodiment.

Firstly, the update control unit 40A of the first information processing device 2A determines whether or not to execute rewriting of the firmware of the power control microcomputer 302 (Step S400). Here, description will be continued on the assumption that the update control unit 40A determines that rewriting of the firmware of the power control microcomputer 302 is to be executed.

The update control unit 40A of the first information processing device 2A transmits a shut-down instruction signal toward the second information processing device 2B before the firmware update of the power control microcomputer 302 (Step S402). The shut-down instruction signal is transmitted to the second information processing device 2B via the relay device 3 (Step S404, Step S406).

Upon receiving the shut-down instruction signal, the third activation control unit 60A of the second information processing device 2B executes shut-down processing of the second information processing device 2B (Step S408). In addition, after executing and completing the shut-down processing, the third activation control unit 60A notifies the power control microcomputer 302 of shut-down completion over the signal lines L2 to L8 (Step S410, Step S412).

Accordingly, the second information processing device 2B enters a state in which processing is normally terminated before the firmware of the power control microcomputer 302 of the relay device 3 is updated.

Upon receiving the shut-down completion notification from the second information processing device 2B, the supply control unit 50D of the power control microcomputer 302 of the relay device 3 switches the change-over switch 307B to an operation voltage supply shut-off (OFF) state (Step S414). As a result, supply of the operation voltage from the power circuit 401B to the second information processing device 2B is shut off.

Next, the reactivation notification unit 40B of the first information processing device 2A transmits a reactivation instruction signal (representing boot loader activation) to the power control microcomputer 302 before the firmware update of the power control microcomputer 302 (Step S416, Step S418).

Upon receiving the reactivation instruction signal (boot loader activation), the power control microcomputer 302 of the relay device 3 executes activation with the rewriting dedicated boot loader 50A. Note that, in the reactivation processing by the rewriting dedicated boot loader 50A, power control is not performed, and also control of the change-over switch 307 is not performed. Accordingly, the change-over switch 307 is maintained without being changed.

Next, the update control unit 40A of the first information processing device 2A transmits, to the relay device 3, an update instruction signal to control firmware update (Step S420). Upon receiving the update instruction signal from the first information processing device 2A, the rewriting dedicated boot loader 50A of the relay device 3 executes firmware update of the power control microcomputer 302 by using update firmware included in the update instruction signal (Step S422).

Upon the firmware update of the power control microcomputer 302 is completed, the reactivation notification unit 40B of the first information processing device 2A transmits, to the relay device 3, a reactivation instruction signal (firmware activation) (Step S424, Step S426).

Upon receiving the reactivation instruction signal (firmware activation) from the first information processing device 2A, the reactivation execution unit 50B of the power control microcomputer 302 of the relay device 3 executes activation with updated firmware of the power control microcomputer 302 (Step S428). By the reactivation processing, the state information managed by the power control microcomputer 302 is initialized (reset).

When the power control microcomputer 302 is reactivated, the determination unit 50C of the relay device 3 determines whether or not this reactivation is carried out immediately after the firmware update of the power control microcomputer 302 (Step S430). Here, description will be continued on the assumption that the reactivation is determined to be carried out immediately after the firmware update.

In a case where it is determined that the reactivation is reactivation immediately after the firmware update, the supply control unit 50D supplies the operation voltage the first information processing device 2A (Step S432). In a state before execution of the reactivation in Step S428, the change-over switch 307A and the change-over switch 402A are in an operation voltage supply (ON) state. In Step S432, the supply control unit 50D does not perform switching to an operation voltage supply shut-off (OFF) state of the change-over switch 307A and the change-over switch 402A. Due to the processing, the supply control unit 50D performs control so that supply of the operation voltage to the first information processing device 2A continues. Accordingly, the change-over switch 307A and the change-over switch 402A for switching supply or supply shut-off of the operation voltage to the first information processing device 2A are maintained in an operation voltage supply (ON) state immediately before the firmware update, during the update, in reactivation after the update, a period immediately after the reactivation.

Next, the changing unit 50E of the relay device 3 changes the state information, which has been initialized due to the reactivation in Step S428, to indicate that the operation voltage is being supplied to the first information processing device 2A (supply of the operation voltage to the second information processing device 2B and the communication control microcomputer is being shut-off) (Step S434). As a result, the state information is changed (or updated) to represent a state of waiting for shut-down of the first information processing device 2A.

Next, for example, the supply control unit 50D of the relay device 3 causes a light source (for example, an LED light source) provided in the power supply unit 402 to flicker as information for promoting a shut-down of the first information processing device 2A (Step S436). For example, the user operates the first information processing device 2A to input a shut-down instruction signal to the first information processing device 2A.

When receiving the shut-down instruction signal, the second activation control unit 40C of the first information processing device 2A executes shut-down processing (Step S438). After executing and completing the shut-down processing, the second activation control unit 40C of the first information processing device 2A notifies the power control microcomputer 302 of shut-down completion over the signal line L1 (Step S440, Step S442).

Upon receiving the shut-down completion notification from the first information processing device 2A, the relay device 3 executes power control necessary for shut-down of the information processing system 1 (Step S444). Specifically, the supply control unit 50D of the relay device 3 switches the change-over switch 307A to an operation voltage supply shut-off (OFF) state. When switching the change-over switch 307A to the operation voltage supply shut-off state, supply of the operation voltage to the first information processing device 2A is shut off. Subsequently, the first activation control unit 50F of the relay device 3 switches the change-over switch 402A to the operation voltage supply shut-off (OFF) state for executing shut-down processing of the relay device 3. When the change-over switch 402A is switched to the operation voltage supply shut-off state, supply of the operation voltage to the relay device 3 is shut off.

In addition, the changing unit 50E of the relay device 3 changes the state information to indicate that supply shut-off of the operation voltage to the first information processing device 2A and the communication control microcomputer 301 is being shut-off (Step S446). That is, the changing unit 50E changes the state information to indicate shut-down completion of the information processing system 1. Then, this sequence is terminated.

As described above, the information processing system 1 of this embodiment includes the first information processing device 2A, the second information processing device 2B, and the relay device 3 that is connected to the first information processing device 2A and the second information processing device 2B over different buses (extension buses). The update control unit 40A of the first information processing device 2A updates firmware of the power control microcomputer 302 provided in the relay device 3. The reactivation notification unit 40B of the first information processing device 2A transmits, to the power control microcomputer 302, a reactivation instruction signal after the firmware is updated. The relay device 3 includes the power control microcomputer 302 that controls supply of the operation voltage to the first information processing device 2A and the second information processing device 2B. The power control microcomputer 302 includes the reactivation execution unit 50B, the determination unit 50C, and the supply control unit 50D. The reactivation execution unit 50B executes reactivation of the power control microcomputer 302 when the reactivation instruction signal is received. The determination unit 50C determines whether or not the executed reactivation is reactivation immediately after the firmware update in the reactivation. In a case where it is determined that the reactivation is reactivation immediately after the firmware update, the supply control unit 50D supplies the operation voltage to the first information processing device 2A.

During the firmware update of the power control microcomputer 302, the supply control of the operation voltage by the power control microcomputer 302 is not executed. In addition, when the power control microcomputer 302 is reactivated after the firmware is updated, supply of the operation voltage to each of the platforms 2 may be forcibly shut off.

On the other hand, in this embodiment, in a case where it is determined that the reactivation is reactivation immediately after the firmware update, the supply control unit 50D of the power control microcomputer 302 performs control so that the operation voltage to the first information processing device 2A is supplied. Accordingly, supply of the operation voltage to the first information processing device 2A is continued. That is, in a case where the firmware of the power control microcomputer 302 is updated, supply of the operation voltage to the first information processing device 2A is suppressed from being suddenly shut off.

Therefore, in this embodiment, it is possible to secure normality of the information processing system 1.

In addition, the power control microcomputer 302 further includes the changing unit 50E. In a case where it is determined that the reactivation is reactivation immediately after the firmware update, the changing unit 50E changes the state information, which has been initialized due to the reactivation, to indicate that the operation voltage is being supplied to the first information processing device 2A.

By doing this, the power control microcomputer 302 can change the state information to have content corresponding to an actual power control situation. Thus, it is possible to further secure normality of the information processing system 1 in addition to the above-described effect.

In addition, the first information processing device 2A includes the second activation control unit 40C. The second activation control unit 40C executes shut-down processing of the first information processing device 2A after the power control microcomputer 302 is notified of the reactivation instruction signal.

According to this, the first information processing device 2A can shut down the first information processing device 2A after the firmware update of the power control microcomputer 302 is normally terminated. According to this, it is possible to further secure the normality of the information processing system 1 in addition to the above-described effect.

In addition, the power control microcomputer 302 includes the first activation control unit 50F. In a case where it is determined that the reactivation is reactivation immediately after the firmware update, the first activation control unit 50F performs control so that the operation voltage is supplied to the first information processing device 2A, and executes shut-down processing of the relay device 3.

Thus, in the information processing system 1 of this embodiment, after updating the firmware of the power control microcomputer 302 of the relay device 3, it is possible to normally terminate each of the first information processing device 2A and the relay device 3 by typical shut-down processing. According to this, it is possible to further secure the normality of the information processing system 1 in addition to the above-described effect.

In addition, the update control unit 40A of the first information processing device 2A transmits, to the second information processing device 2B, a shut-down instruction signal before the firmware update of the power control microcomputer 302. Upon receiving the shut-down instruction signal, the third activation control unit 60A of the second information processing device 2B executes shut-down processing of the second information processing device 2B. According to this, in the information processing system 1 of this embodiment, in the case of updating the firmware of the power control microcomputer 302 of the relay device 3, it is possible to normally terminate the second information processing device 2B by typical shut-down processing before the firmware update. According to this, it is possible to further secure the normality of the information processing system 1 in addition the above-described effect.

### Modification Example

In the above embodiment, description has been given of an aspect in which the relay device 3 and the first information processing device 2A are shut down after updating the firmware of the power control microcomputer 302. Alternatively, after updating the firmware of the power control microcomputer 302, the relay device 3 and the first information processing device 2A may not be shut down, and the second information processing device 2B may be activated to set the information processing system 1 to a state in which activation is completed.

In this case, in the information processing system 1, the following processing may be executed.

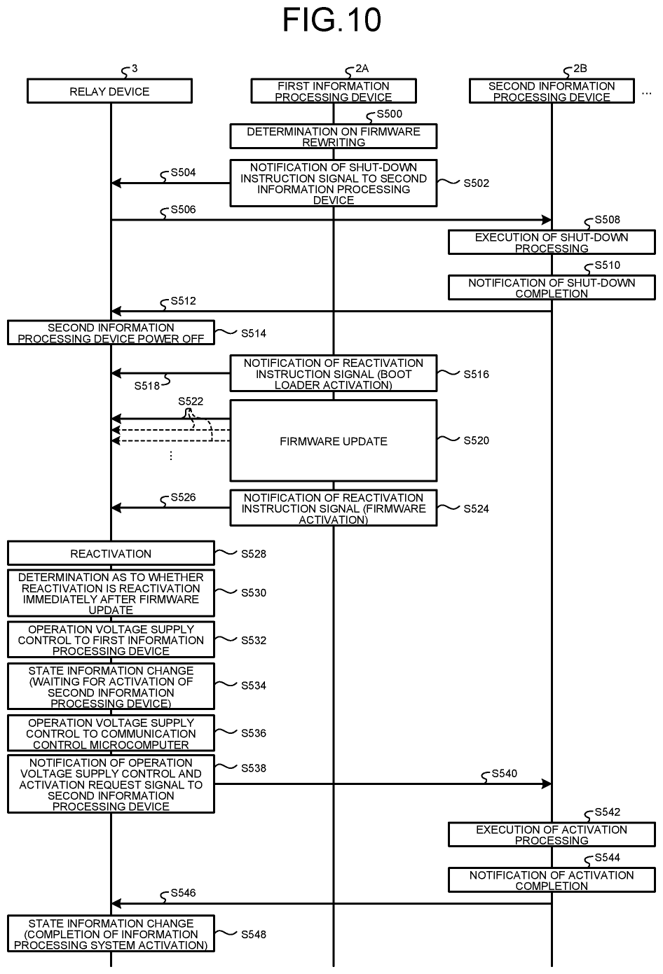

FIG. 10 is a sequence diagram illustrating an example of a flow of firmware update of an information processing system 1 according to a modification example.

The information processing system 1 executes processing in Step S500 to processing in Step S534 in a similar manner as in the processing in Step S400 to the processing in Step S434 of the foregoing embodiment (FIG. 9).

That is, the update control unit 40A of the first information processing device 2A determines whether or not to execute rewriting of the firmware of the power control microcomputer 302 (Step S500). The update control unit 40A of the first information processing device 2A transmits, toward the second information processing device 2B, a shut-down instruction signal before the firmware update of the power control microcomputer 302 (Step S502). The shut-down instruction signal is transmitted to the second information processing device 2B via the relay device 3 (Step S504, Step S506).

Upon receiving the shut-down instruction signal, the third activation control unit 60A of the second information processing device 2B executes shut-down processing of the second information processing device 2B (Step S508). In addition, after executing and completing the shut-down processing, the third activation control unit 60A notifies the power control microcomputer 302 of shut-down completion over the signal lines L2 to L8 (Step S510, Step S512).

Upon receiving the shut-down completion notification from the second information processing device 2B, the supply control unit 50D of the power control microcomputer 302 of the relay device 3 switches the change-over switch 307B to an operation voltage supply shut-off (OFF) state (Step S514). According to this, the second information processing device 2B enters the operation voltage supply shut-off state in which supply of the operation voltage is shut off.

Next, the reactivation notification unit 40B of the first information processing device 2A transmits, to the power control microcomputer 302, a reactivation instruction signal (boot loader activation) before the firmware update of the power control microcomputer 302 (Step S516, Step S518). Upon receiving the reactivation instruction signal (boot loader activation), the power control microcomputer 302 of the relay device 3 executes activation with the rewriting dedicated boot loader 50A.

Next, the update control unit 40A of the first information processing device 2A controls firmware update by transmitting an update instruction signal to the relay device 3 (Step S520). Upon receiving the update instruction signal from the first information processing device 2A, the rewriting dedicated boot loader 50A of the relay device 3 executes firmware update of the power control microcomputer 302 by using update firmware included in the update instruction signal (Step S522).

When the firmware update of the power control microcomputer 302 is completed, the reactivation notification unit 40B of the first information processing device 2A transmits, to the relay device 3, a reactivation instruction signal (firmware activation) (Step S524, Step S526).

Upon receiving the reactivation instruction signal (firmware activation) from the first information processing device 2A, the reactivation execution unit 50B of the power control microcomputer 302 of the relay device 3 executes activation with updated firmware of the power control microcomputer 302 (Step S528).

When the power control microcomputer 302 is reactivated, the determination unit 50C of the relay device 3 determines whether or not the reactivation is reactivation immediately after the firmware update of the power control microcomputer 302 (Step S530). Here, description will be continued on the assumption that the reactivation is determined as reactivation immediately after the firmware update.

In a case where it is determined that the reactivation is reactivation immediately after the firmware update, the supply control unit 50D supplies the operation voltage to the first information processing device 2A (Step S532). Next, the changing unit 50E of the relay device 3 changes the state information, which has been initialized due to the reactivation in Step S528, to indicate that the operation voltage is being supplied to the first information processing device 2A and supply of the operation voltage to the second information processing device 2B and the communication control microcomputer 301 is shut-off (Step S534). According to this, the state information is changed to represent a state of waiting for activation of the second information processing device 2B.

In this modification example, in Step S530, in a case where it is determined that the reactivation is reactivation immediately after the firmware update, the supply control unit 50D of the relay device 3 performs supply (ON) of the operation voltage to the communication control microcomputer 301 (Step S536). In Step S536, the supply control unit 50D controls the change-over switch 307C so that the operation voltage is supplied to the communication control microcomputer 301. That is, the supply control unit 50D switches the change-over switch 307C to an operation voltage supply (ON) state. Subsequently, supply (ON) of the operation voltage and an activation request signal is transmitted to the second information processing device 2B, on which the shut-down processing has been executed (Step S538, Step S540). In Step S538, the supply control unit 50D controls the change-over switch 307B to supply the operation voltage to the second information processing device 2B. That is, the supply control unit 50D switches the change-over switch 307B to an operation voltage supply (ON) state. Subsequently, in Step S540, the supply control unit 50D transmits, to the second information processing device 2B, an activation request signal over the signal lines L2 to L8.

The third activation control unit 60A of the second information processing device 2B, which has received the activation request signal, executes activation processing of the second information processing device 2B (Step S542). Specifically, the third activation control unit 60A executes activation of OS of the second information processing device 2B and loading of various drivers. In addition, after completing the activation processing, the third activation control unit 60A notifies the power control microcomputer 302 of activation completion over the signal lines L2 to L8 (Step S544, Step S546).

Upon receiving the activation completion notification from the second information processing device 2B, the changing unit 50E of the relay device 3 changes the state information to indicate that the operation voltage is being supplied to the first information processing device 2A and the second information processing device 2B” (Step S548). According to this, the state information is changed to indicate the activation completion of the information processing system 1. Then, the sequence is terminated.

As described above, in this modification example, in a case where the determination unit 50C of the power control microcomputer 302 determines that the reactivation is reactivation immediately after the firmware update, the operation voltage is supplied to the first information processing device 2A, the operation voltage is supplied to the communication control microcomputer 301, and the operation voltage is supplied to the second information processing device 2B, which is notified of the shut-down instruction signal by the update control unit 40A before the firmware update of the power control microcomputer 302 and on which the shut-down processing has been executed, and after that, the activation request signal is transmitted.

That is, in this modification example, after the firmware update of the power control microcomputer 302, the relay device 3 and the first information processing device 2A are not shut down, and the communication control microcomputer 301 and the second information processing device 2B that is shut down before the firmware update are activated to set the information processing system 1 (the relay device 3 and the platforms 2 (the first information processing device 2A and the second information processing device 2B)) to an activated state.

As described above, with regard to a case where the relay device 3 and the platforms 2 (the first information processing device 2A and the second information processing device 2B) are set to an activated state after the firmware update of the power control microcomputer 302, as in the foregoing embodiment, the determination unit 50C determines whether or not the reactivation is reactivation immediately after the firmware update. In addition, in a case where it is determined that the reactivation is reactivation immediately after the firmware update, the supply control unit 50D supplies the operation voltage to the first information processing device 2A and the second information processing device 2B.

According to this, even in a case where the firmware of the power control microcomputer 302 is updated, the supply of the operation voltage to the first information processing device 2A and the second information processing device 2B is suppressed from being suddenly shut off.

Accordingly, in this modification example, it is possible to secure the normality of the information processing system 1.

Note that, in the embodiment and the modification example, description has been made in a state in which the PCIe is exemplified as the I/O interface of respective units. However, the I/O interface is not limited to the PCIe. For example, the I/O interface of each unit may be a technology capable of performing data transfer between a device (periphery control controller) and a processor by a data transfer bus. The data transfer bus may be a general-purpose bus capable of transferring data at a high speed in a local environment (for example, one system or one device) provided in a single housing or the like. The I/O interface may be any one of a parallel interface or a serial interface.

The I/O interface may have a configuration that is capable of establishing point-to-point access, and is capable of serially transferring data in a packet base. Note that, the I/O interface may include a plurality of lanes in the case of the serial transfer. A layer structure of the I/O interface may include a transaction layer that performs generation and decoding of packets, a data link layer that performs error detection or the like, and a physical layer that performs conversion between serial and parallel. In addition, the I/O interface may include a root complex that is an uppermost layer and includes one or a plurality of ports, an end point that is an I/O device, a switch for extending ports, a bridge that converts a protocol, and the like. The I/O interface may transmit transmission data and a clock signal in a state of being multiplexed by a multiplexer. In this case, a reception side may separate the data and the clock signal by a demultiplexer.

What is claimed is:

1. An information processing system comprising:
a first information processing device;
a second information processing device; and
a relay device connected to the first information processing device and the second information processing device over different buses, the relay device being provided with a power control microcomputer to control supply of operation voltage to the first information processing device and the second information processing device, wherein
the first information processing device:
updates firmware of the power control microcomputer; and
transmits, to the power control microcomputer, a reactivation instruction signal after the firmware is updated, and
the power control microcomputer:
executes reactivation of the power control microcomputer when the reactivation instruction signal is received from the first information processing device;
determines whether or not the executed reactivation is reactivation that is executed immediately after the firmware update; and
supplies the operation voltage to the first information processing device upon determining that the executed reactivation is reactivation immediately after the firmware update.

2. The information processing system according to claim 1, wherein the power control microcomputer further:
holds state information representing a power control situation of the first information processing device and the second information processing device; and
upon determining that the executed reactivation is reactivation immediately after the firmware update, changes the state information that has been initialized due to the executed reactivation and indicates that the operation voltage is being supplied to the first information processing device.

3. The information processing system according to claim 2, wherein the first information processing device further executes shut-down processing of the first information processing device after the reactivation instruction signal is transmitted to the power control microcomputer.

4. The information processing system according to claim 2, wherein, upon determining that the executed reactivation is reactivation immediately after the firmware update, the power control microcomputer further executes shut-down processing of the relay device after carrying out the supply of the operation voltage to the first information processing device.

5. The information processing system according to claim 1, wherein
the first information processing device further transmits a shut-down instruction signal to the second information processing device via the power control microcomputer before carrying out the firmware update of the power control microcomputer, and
the second information processing device further executes the shut-down processing of the second information processing device when the shut-down instruction signal is received via the power control microcomputer.

6. The information processing system according to claim 5, wherein, upon determining that the executed reactivation is reactivation immediately after the firmware update, the power control microcomputer further transmits, after supplying the operation voltage to the second information processing device, an activation request signal to the second information processing device that has executed the shut-down processing.

7. A relay device to which a first information processing device and a second information processing device are connected over different buses, the relay device comprising:
a power control microcomputer to control supply of operation voltage to a first information processing device and a second information processing device, wherein the power control microcomputer:
executes reactivation of the power control microcomputer when a reactivation instruction signal is received from the first information processing device;
determines whether or not the executed reactivation is reactivation that is executed immediately after firmware update of the power control microcomputer; and
supplies the operation voltage to the first information processing device upon determining that the executed reactivation is reactivation immediately after the firmware update.
